(19) United States
(12) Patent Application Publication
(10) Pub. No.: US 2025/0188879 A1
(43) Pub. Date: Jun. 12, 2025

(54) FUEL SUPPLY SYSTEM FOR A POWER GENERATION SYSTEM

(71) Applicant: BorgWarner Inc., Auburn Hills, MI (US)

(72) Inventor: Mathias Kosch, Mainz (DE)

(21) Appl. No.: 18/971,321

(22) Filed: Dec. 6, 2024

(30) Foreign Application Priority Data
Dec. 7, 2023 (DE) 10 2023 134 270.3

(51) Int. Cl. F02C 9/40; F02C 3/22

(52) U.S. Cl. CPC F02C 9/40; F02C 3/22; F05D 2220/76; F05D 2240/35; F05D 2270/301

(57) ABSTRACT

The present invention relates to a fuel supply system (10) for a power generation system (1), in particular for a micro gas turbine system. The fuel supply system (10) comprises a fuel supply line (110), a fuel main line (120) and a fuel distribution line (130), a fuel compressor (200), and a decoupling vessel (300). The fuel supply line (110) is fluidically connected to the fuel compressor (200) and is able to be connected to a fuel source (11) in order to supply fuel from the fuel source (11) to the fuel compressor (200). The decoupling vessel (300) is disposed downstream of the fuel compressor (200) and is fluidically connected to the fuel compressor (200) by way of the fuel main line (120). The fuel distribution line (130) is disposed downstream of the decoupling vessel (300) and is fluidically connected to the latter. The fuel distribution line (130) is able to be fluidically connected to at least one combustion unit (20) of the power generation system (1), and is conceived to supply the at least one combustion unit (20) with fuel from the decoupling vessel (300).

### TECHNICAL FIELD

The present invention relates to a fuel supply system for a power generation system, in particular for a (micro) gas turbine system. Furthermore, the present invention relates to a power generation system, in particular a (micro) gas turbine system, having a fuel supply system of this type, and to a method for controlling the fuel supply system for a power generation system.

### BACKGROUND

Power generation systems, in particular gas turbine systems or micro gas turbine systems, are used to generate electric power and/or heat by combusting a gaseous or liquid fluid (in particular a fuel). The medium combusted in a combustion unit can relax in a turbine, the latter in turn potentially being functionally connected to a generator for generating electric power. Additionally or alternatively, a heat exchanger can be provided for utilizing the waste heat generated by the combustion. Depending on the requirement, power generation systems may have one or a plurality of (micro) gas turbines, each of the latter having one combustion unit. The gas turbines herein can in each case provide identical outputs or different outputs. Due to a different operating state (for example a non-stationary operation) and/or different load states, one dedicated fuel supply system is required per gas turbine, in particular for power generation systems which have a plurality of (micro) gas turbines with in each case one combustion unit. Consequently, the combustion units are in each case supplied by one dedicated fuel supply system in order to be able to provide fuel to the individual combustion units at a specific pressure, a specific temperature and/or a specific mass flow (or a flow rate), which is adapted to the corresponding output, the operating state and/or load state. Each fuel supply system usually has a plurality of components such as lines, seals, valves, and pumps or compressors. Some of the components, such as actuatable valves, for example, can be actively controlled in order to provide fuel with specific parameters such as a flow rate. Other components can be safety components which meet specific safety standards of the overall system and are intended to ensure that critical events do not arise. The safety standards herein permit various configurations of fuel supply systems. However, known fuel supply systems, and in particular a fuel supply system per gas turbine, apart from a supercharger, also require a primary gas compressor by means of which a specific pressure, or mass flow, can be provided at the respective combustion units. Power generation systems with one or a plurality of known fuel supply systems require a high number of components, which leads to high costs, a high requirement in terms of space, and high complexity. Moreover, the known fuel supply systems are restricted in terms of their range of application.

It is an object of the present invention to provide an improved fuel supply system for a power generation system, in particular for a (micro) gas turbine system.

### SUMMARY OF THE INVENTION

The present invention relates to a fuel supply system for a power generation system, in particular for a gas turbine system or a micro gas turbine system, as claimed in claim 1. The present invention furthermore relates to a power generation system, in particular a (micro) gas turbine system, having a fuel supply system of this type as claimed in claim 10, and to a method for controlling a fuel supply system for a power generation system as claimed in claim 16. The dependent claims describe advantageous design embodiments of the fuel supply system, of the power generation system and of the method.

According to a first aspect of the present invention, a fuel supply system for a power generation system, in particular for a gas turbine system or a micro gas turbine system, comprises a fuel supply line, a fuel main line, and a fuel distribution line. Moreover, the fuel supply system comprises a fuel compressor and a decoupling vessel. The fuel supply line is fluidically connected to the fuel compressor and able to be connected to a fuel source in order to supply fuel from the fuel source to the fuel compressor. The decoupling vessel is disposed downstream of the fuel compressor and is fluidically connected to the fuel compressor by way of the fuel main line. The fuel distribution line is disposed downstream of the decoupling vessel and is fluidically connected to the latter. The fuel distribution line is able to be fluidically connected to at least one combustion unit of a power generation system, and is conceived to supply the at least one combustion unit with fuel from the decoupling vessel.

One or a plurality of combustion units can be reliably supplied with fuel by means of the fuel supply system according to the invention. In particular, by providing the decoupling vessel, one or a plurality of combustion units can be supplied by only one single fuel supply system, even under different load states, operating states (e.g. non-stationary operation) and/or different output levels. The required target pressure in the decoupling vessel can be provided by the fuel compressor, this leading to a reduction of components in particular in power generation systems having a plurality of (micro) gas turbines. Costs and/or the complexity of the system can likewise be reduced as a result. Because only one fuel compressor is required conjointly with the decoupling vessel, an installation space, or space requirement, can be reduced. More specifically, many additional components such as individual main gas compressors and/or superchargers can be dispensed with (in particular in comparison to a plurality of fuel supply systems) by means of the decoupling vessel in the fuel supply system. Moreover, the decoupling vessel and the fuel compressor can be provided outside the combustion unit, this leading to a simplification of the system (in known systems, these items are often integrated into the respective combustion units). Additional components such as, for example, respective separate oil supplies for the main gas compressor and/or supercharger can be dispensed with. Moreover, an application range of the fuel supply system can be enlarged.

The decoupling vessel can also be referred to as a decoupling tank. In this context, “decoupling vessel or decoupling tank” are intended to mean that an (intermediate) component is provided between one or a plurality of compressors and at least one downstream consumer (in particular the at least one combustion unit) of compressed fuel. The decoupling vessel makes it possible that one or a plurality of consumers, in particular one or a plurality of combustion units, can be supplied from the decoupling vessel of the fuel supply system. This is provided in that fuel with a fuel parameter target value, in particular a fuel pressure target value, can be provided and/or stored in the decoupling vessel. The fuel pressure target value here can correspond to a maximum required fuel pressure target value of the one or the plurality of combustion units. In other words, a fuel line, in which fuel is compressed by means of a compressor, is not connected directly to one or a plurality of consumers but is “decoupled” from the one or the plurality of consumers by way of the intermediate component in the form of the decoupling vessel. Of course, the fuel supply to a consumer can also be influenced or suppressed by a shut-off valve or a throttle valve; however, the function of fuel storage and/or the provision of fuel with the fuel parameter target value cannot be provided in this case. In particular, a plurality of consumers or combustion units which (for example due to different load states, operating states and/or output levels) can in each case at least in part have a different fuel parameter target value (e.g. a fuel pressure target value) cannot be supplied from the decoupling vessel there either. In design embodiments the fuel supply line can be optional, for example when the fuel compressor is able to be connected directly to the fuel source, or is connected directly to the latter.

In design embodiments the fuel supply system can comprise exactly one fuel compressor, in particular a high-pressure fuel compressor. The fuel can be a gaseous fuel, in particular propane, natural gas, hydrogen or biogas.

In design embodiments the fuel distribution line can be able to be fluidically connected to at least two combustion units of the power generation system, and conceived to supply the at least two combustion units with fuel from the decoupling vessel. For example, the at least two combustion units can have different output levels, different load states and/or different operating states. The at least two combustion units can require different fuel parameter values, for example different fuel pressure values. The decoupling vessel can be conceived to supply the at least two combustion units with fuel with a respective required fuel parameter value. In the decoupling vessel, fuel with a fuel parameter target value which corresponds to a maximum required fuel parameter value of the at least two combustion units can be provided. The fuel distribution line can comprise at least two sub-lines which are in each case connected to the at least two combustion units.

In design embodiments the power generation system can comprise at least one gas turbine which has the at least one combustion unit. The fuel distribution line can be able to be fluidically connected to the combustion unit of the at least one gas turbine of the power generation system, and conceived to supply the combustion unit of the at least one gas turbine with fuel from the decoupling vessel.

In design embodiments the power generation system can comprise at least two gas turbines which have in each case one combustion unit. The fuel distribution line can be able to be fluidically connected to the respective combustion unit of the at least two gas turbines of the power generation system, and conceived to supply the respective combustion units of the at least two gas turbines with fuel from the decoupling vessel.

In design embodiments the fuel supply system can comprise at least one fuel heat exchanger. The latter can be disposed in the fuel main line so as to be downstream of the fuel compressor, and conceived to discharge heat from the fuel main line.

In design embodiments the fuel supply system can comprise at least one ventilation line which fluidically connects the fuel main line and an atmospheric outlet of the ventilation line, or of the fuel supply system.

In design embodiments the fuel supply system can comprise at least one ventilation valve in the at least one ventilation line. In an open position of the at least one ventilation valve, the ventilation line can be conceived to discharge fuel from the fuel main line.

In design embodiments the at least one ventilation line can be fluidically connected to a combustion unit supply line, and conceived to discharge fuel from the combustion unit supply line.

In design embodiments the fuel supply system can comprise exactly one decoupling vessel. In design embodiments a plurality of decoupling vessels can also be provided. The latter can be provided so as to be connected in parallel. As a result, an energetic optimization can be provided in the case of greatly different output levels of a plurality of gas turbines. In design embodiments, said decoupling vessels can also be provided in series. In design embodiments the decoupling vessel can comprise a plurality of vessel chambers. Alternatively, the decoupling vessel can comprise exactly one vessel chamber. In design embodiments the decoupling vessel can comprise at least two vessel chambers. The fuel distribution line can comprise at least two separate sub-lines. Each vessel chamber can be able to be fluidically connected to a respective combustion unit by way of a corresponding sub-line. The fuel main line can comprise at least two sub-lines which connect in each case the fuel main line to a respective vessel chamber.

In design embodiments the fuel supply system can comprise a decoupling vessel bypass which fluidically connects the fuel main line and the fuel distribution line. The decoupling vessel bypass can be conceived to supply fuel from the fuel main line to the fuel distribution line while bypassing the decoupling vessel. The decoupling vessel bypass can in particular be used when a plurality of combustion units of gas turbines are supplied, which comprise in each case the same (low) output levels, or when only the combustion unit of one gas turbine is supplied with fuel.

In design embodiments the fuel supply system can comprise at least one check valve which is disposed in the fuel main line so as to be upstream of the decoupling vessel. The check valve can prevent a return flow of compressed fuel from the decoupling vessel, in particular when the fuel compressor is not being operated, or is being operated at low rotating speeds (thus only a pressure being built up that is lower than a pressure in the decoupling vessel).

In design embodiments the fuel compressor can be conceived to provide fuel with a fuel parameter target value, in particular a fuel pressure target value, in the decoupling vessel.

In design embodiments the fuel supply system can comprise a fuel compressor bypass which fluidically connects the fuel supply line and the fuel main line, and is conceived to supply fuel from the fuel supply line to the fuel main line while bypassing the fuel compressor. For example, the fuel source can already provide fuel at a specific pressure level. If this pressure level corresponds to at least the fuel pressure target value in the decoupling vessel, for example in low-load states of the at least one combustion unit, the fuel compressor bypass can be opened.

In design embodiments the fuel supply system can comprise at least one first shut-off valve which is disposed in the fuel main line so as to be downstream or upstream of the fuel compressor. A fuel supply can be shut off or suppressed quickly and centrally by means of the shut-off valve, for example in a hazardous situation, an emergency situation or a maintenance situation.

In design embodiments the fuel supply system can comprise at least one filter device which is disposed in the fuel supply line so as to be upstream of the fuel compressor. In design embodiments the fuel supply system can comprise at least one pressure reduction valve which is disposed in the fuel distribution line so as to be downstream of the decoupling vessel.

In design embodiments the fuel supply system can comprise at least one first pressure sensor and/or one first temperature sensor which is disposed in the fuel supply line, the fuel main line and/or in the fuel distribution line. In design embodiments the fuel supply system can comprise at least one mass flow sensor which is disposed in the fuel main line so as to be upstream of the decoupling vessel, and is conceived to measure a mass flow in the fuel main line ahead of the decoupling vessel.

In design embodiments, the fuel source can be a supply network, in particular a supply network of, for example, a decentralized energy supply. In other design embodiments the fuel source can be a fuel store.

According to a second aspect of the present invention, a power generation system, in particular a gas turbine system or a micro gas turbine system, comprises a fuel supply system according to the first aspect of the present invention, and at least one combustion unit. The at least one combustion unit is disposed downstream of the fuel supply system and is fluidically connected to the decoupling vessel by way of the fuel distribution line, wherein the at least one combustion unit is supplied with fuel from the decoupling vessel. As a result of this system, the advantageous effects of the power generation system described above can likewise be provided. A micro gas turbine system is understood to be a system which has one or a plurality of micro gas turbines which can in each case provide an output of 30 kW to 500 kW. However, the design embodiments described herein can also be applied to gas turbine systems with a higher output.

In design embodiments the power generation system can comprise at least one (micro) gas turbine which has the at least one combustion unit. The fuel distribution line can be fluidically connected to the combustion unit of the at least one gas turbine of the power generation system, and supply the combustion unit of the at least one gas turbine with fuel from the decoupling vessel.

In design embodiments the power generation system can comprise at least two combustion units which are disposed downstream of the fuel supply system and are fluidically connected to the decoupling vessel by way of the fuel distribution line. The at least two combustion units can be supplied with fuel from the decoupling vessel. The fuel distribution line can have a plurality of sub-lines which in this instance branch off in each case from the fuel distribution line to the respective combustion units. In other design embodiments the fuel distribution line can have a plurality of sub-lines which are provided separately from one another and connect the respective combustion units separately to the decoupling vessel.

In design embodiments the power generation system can comprise at least two (micro) gas turbines which have in each case one combustion unit. The fuel distribution line can be fluidically connected to the respective combustion unit of the at least two gas turbines of the power generation system, and supply the respective combustion units of the at least two gas turbines with fuel from the decoupling vessel.

In design embodiments the at least one combustion unit can comprise a combustion unit supply line and at least one burner. The combustion unit supply line can fluidically connect the burner to the fuel distribution line. In design embodiments the at least one burner can comprise a main burner and a pilot burner.

In design embodiments the fuel supply system can comprise at least one ventilation line which fluidically connects the combustion unit supply line and an atmospheric outlet of the ventilation line, in particular of the fuel supply system.

In design embodiments the at least two (micro) gas turbines can provide the same output, or provide different outputs.

In design embodiments the combustion unit can have at least one second mass flow sensor which is disposed in the combustion unit supply line, and is conceived to measure a mass flow in the combustion unit supply line.

In design embodiments the combustion unit can have at least one pressure adjustment element which is disposed in the combustion unit supply line, and is conceived to adjust a fuel parameter value of the fuel, in particular a fuel pressure value, in the combustion unit supply line. In design embodiments the at least one pressure adjustment element can be conceived to maintain the fuel parameter value, in particular the fuel pressure value, between a lower and an upper pressure threshold value.

In design embodiments the combustion unit can comprise at least one second pressure sensor and/or one second temperature sensor which is disposed in the combustion unit supply line.

In design embodiments the power generation system can comprise a first proportional valve and at least one second proportional valve. The first proportional valve can be disposed in a first sub-line of the combustion unit supply line so as to be upstream of the main burner. The second proportional valve can be disposed in a second sub-line of the combustion unit supply line so as to be upstream of the pilot burner. The first proportional valve and the at least one second proportional valve can be conceived to control a fuel proportion which is in each case to be supplied to the main burner and the pilot burner.

In design embodiments the at least one gas turbine can comprise a compressor unit which is disposed upstream of the combustion unit and is fluidically connected to the latter. In design embodiments the compressor unit can be fluidically connected to a mixing zone of the at least one burner, and be conceived to supply compressed air to the mixing zone. The mixing zone can be conceived to mix the fuel and the compressed air.

In design embodiments the at least one gas turbine can comprise a turbine unit which is disposed downstream of the combustion unit and is fluidically connected to the latter. In design embodiments the at least one gas turbine can comprise a generator unit which is operatively connected to the turbine unit. In design embodiments the gas turbine can comprise a shaft which is rotationally mounted in a bearing housing. A rotor of the generator unit can be co-rotationally coupled to the turbine unit by way of the shaft. In design embodiments the turbine unit can be co-rotationally coupled to the compressor unit by way of the shaft.

In design embodiments the at least one gas turbine can have a first gas turbine line and a second gas turbine line. The first gas turbine line can fluidically connect the turbine unit to the combustion unit. The second gas turbine line can be disposed downstream of the turbine unit and be fluidically connected to the latter. The second gas turbine line can be conceived to discharge relaxed fluid from the turbine unit.

In design embodiments the at least one gas turbine can comprise a third gas turbine line which fluidically connects the compressor unit to the combustion unit and is conceived to supply compressed air to the combustion unit.

In design embodiments the at least one gas turbine can comprise at least one recuperator unit. The at least one recuperator unit can be disposed in the first gas turbine line and the second gas turbine line in such a manner and be specified in such a manner so as to transmit a thermal output from the first gas turbine line to the second gas turbine line. In design embodiments the at least one recuperator unit can also be disposed between the third gas turbine line and the second gas turbine line in such a manner and be specified in such a manner so as to transmit a thermal output from the third gas turbine line to the second gas turbine line. The at least one recuperator unit can also comprise a first recuperator unit and a second recuperator unit which are disposed at the positions described above.

According to a third aspect of the present invention, a method for controlling a fuel supply system for a power generation system, in particular a fuel supply system according to the first aspect of the present invention, can comprise the following steps:
a) requesting and obtaining at least one fuel parameter target value which is linked to fuel in a decoupling vessel;
b) determining, based on the at least one fuel parameter target value, at least one operating parameter value of a fuel compressor which is fluidically connected to the decoupling vessel;
c) operating the fuel compressor based on the at least one operating parameter, so as to provide fuel with the at least one fuel parameter target value in the decoupling vessel.

This method can provide the advantageous effects of the fuel supply system and of the power generation system described above. The method can be applied in a manner analogous to the control of the power generation system according to the second aspect of the present invention. According to one aspect of the present invention, a method for controlling a power generation system, in particular a (micro) gas turbine system according to the second aspect of the present invention, can consequently comprise all steps and features of the method described. The fuel supply system and the power generation system can comprise the features or design embodiments described above.

In design embodiments the method can furthermore comprise the following step: supplying at least one combustion unit with fuel with the at least one fuel parameter target value from the decoupling vessel.

In design embodiments the at least one fuel parameter target value can be a fuel pressure target value in the decoupling vessel. In design embodiments the at least one operating parameter value can be a rotating speed of the fuel compressor.

In design embodiments the power generation system can comprise a first gas turbine and at least one second gas turbine. Requesting and obtaining at least one fuel parameter target value can comprise the following steps:
obtaining a first required fuel parameter value which is linked to fuel that is required for supplying a combustion unit of the first gas turbine;
obtaining at least one second required fuel parameter value which is linked to fuel that is required for supplying a combustion unit of the at least one second gas turbine;
determining which fuel parameter value of the first required fuel parameter value and of the at least one second required fuel parameter value has the highest fuel parameter value; and
establishing the fuel parameter target value in such a manner that it corresponds at least to the highest required fuel parameter value.

In design embodiments the method can furthermore comprise the following steps: requesting and obtaining at least one second fuel parameter target value which is linked to fuel in a fuel distribution line, wherein the fuel distribution line is disposed downstream of the decoupling vessel and is fluidically connected to the latter;
determining the at least one operating parameter value of the fuel compressor based on the at least one second fuel parameter target value;
operating the fuel compressor based on the at least one operating parameter, in order to provide fuel with the at least one second fuel parameter target value in the fuel distribution line.

In design embodiments the at least one second fuel parameter target value can be a fuel mass flow target value in the fuel distribution line.

In design embodiments the method can be a computer-implemented method. The supply of at least one combustion unit with fuel with the at least one fuel parameter target value herein can be implemented by correspondingly activating at least one outlet valve element which is provided between the decoupling vessel and the fuel distribution line, for example. The operation of the fuel compressor based on the at least one operating parameter herein can be implemented by activating a drive device (for example an electric motor) which is coupled to a rotatable compressor wheel of the fuel compressor.

Configured according to a fourth aspect of the present invention is a computer system for carrying out the computer-implemented method according to the third aspect of the present invention.

Configured according to a fifth aspect of the present invention is a computer program for carrying out the computer-implemented method according to the third aspect of the present invention.

Provided according to a sixth aspect of the present invention is a computer-readable medium or signal which stores the computer program according to the fifth aspect of the present invention.

### BRIEF DESCRIPTION OF THE FIGURES

FIG. 1 shows a schematic view of a fuel supply system according to the invention for a power generation system, connected to at least one combustion unit;

FIG. 2 shows a detailed view of the fuel supply system according to the invention and of the at least one combustion unit from FIG. 1;

FIG. 3 shows a power generation system according to the invention, having the fuel supply system and at least one gas turbine;

FIG. 4 shows a schematic sequence diagram of the method according to the invention for controlling the fuel supply system; and

FIG. 5 shows the fuel supply system according to the invention, having a decoupling vessel which can have a plurality of vessel chambers.

### DETAILED DESCRIPTION

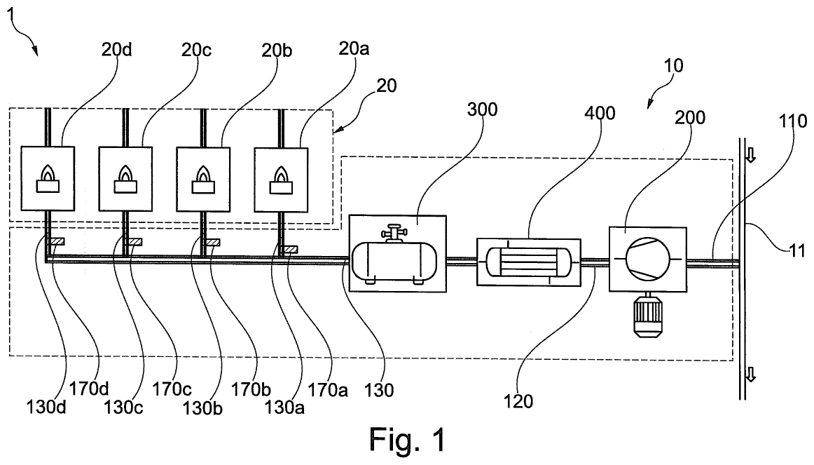

FIG. 1 shows a schematic view of a fuel supply system 10 for a power generation system 1, in particular for a gas turbine system or a micro gas turbine system, according to one aspect of the present invention.

The fuel supply system 10 comprises a fuel supply line 110, a fuel main line 120 and a fuel distribution line 130. Moreover, the fuel supply system comprises a fuel compressor 200 and a decoupling vessel 300. As is schematically illustrated in FIG. 1, the fuel supply line 110 is at one end fluidically connected to the fuel compressor 200. At the other end, the fuel supply line 110 is able to be fluidically connected to a fuel source 11, so as to supply fuel from the fuel source 11 to the fuel compressor 200. The fuel supply line 110 in FIG. 1 is illustrated so as to be fluidically connected to the fuel source 11. The decoupling vessel 300 is disposed downstream of the fuel compressor 200 and is fluidically connected to the fuel compressor 200 by way of the fuel main line 120. The fuel distribution line 130 is disposed downstream of the decoupling vessel 300, and at a first end is fluidically connected to the decoupling vessel. The fuel distribution line 130 is at a second end able to be fluidically connected to at least one combustion unit 20 of a power generation system 1, in particular of a (micro) gas turbine system, and is conceived to supply the at least one combustion unit 20 with fuel from the decoupling vessel 300. The fuel distribution line 130 in FIG. 1 is fluidically connected to the at least one combustion unit 20.

One or a plurality of combustion units 20 can be reliably supplied with fuel by means of the fuel supply system 10 according to the invention. In particular, by providing the decoupling vessel 300, one or a plurality of combustion units 20, 20a, 20b, 20c, 20d can be supplied by only one single fuel supply system 10 even at different loads, operating states (e.g. non-stationary operation) and/or different output levels. The fuel compressor 200 is conceived to provide fuel with a fuel pressure target value in the decoupling vessel 300. Consequently, a target pressure (or fuel with a fuel pressure target value) required for the supply can be provided in the decoupling vessel 300 by the fuel compressor 200, which can lead to a reduction of components in particular in power generation systems 1 having a plurality of (micro) gas turbines 2, 2a, 2b. Costs and/or the complexity of the overall system can likewise be reduced as a result. Because only one fuel compressor 200 is required conjointly with the decoupling vessel 300, an installation space, or space requirement, can be reduced. More specifically, many additional components such as individual main gas compressors and/or superchargers can be dispensed with (in particular in comparison to a plurality of individual fuel supply systems per combustion unit) by means of the decoupling vessel 300 in the fuel supply system 10. Moreover, the decoupling vessel 300 and the fuel compressor 200 can be provided outside the combustion unit 20, which can lead to a simplification of the system (in known systems, these items are often integrated into the respective combustion units). Additional components such as, for example, respective separate oil supplies for the main gas compressor and/or the supercharger can likewise be dispensed with. Moreover, an application range of the fuel supply system 10 can be enlarged.

The decoupling vessel 300 can also be referred to as the decoupling tank. In this context, “decoupling vessel 300, or decoupling tank” is intended to mean that an (intermediate) component is provided between one or a plurality of compressors 200 and at least one downstream consumer (in particular the at least one combustion unit 20) of compressed fuel. The decoupling vessel 300 makes it possible that one or a plurality of consumers, in particular one or a plurality of combustion units 20, can be supplied from the decoupling vessel 300 of the (single) fuel supply system 10. This is provided in that fuel with a fuel parameter target value, in particular a fuel pressure target value, can be provided and/or stored in the decoupling vessel 300. The fuel parameter target value here can correspond to at least a maximum required fuel pressure value of the one or the plurality of combustion units 20. In other words, the fuel line in which fuel is compressed by means of the fuel compressor cannot be connected directly to one or a plurality of consumers, but can be “decoupled” from the one or the plurality of consumers by way of the intermediate component in the form of the decoupling vessel 300. Of course, the fuel supply to a consumer can also be influenced or suppressed by a shut-off valve or throttle valve; however, the function of fuel storage and/or the provision of fuel with the fuel parameter target value for a plurality of consumers, in particular combustion units 20, cannot be provided in this case. Consequently, a plurality of consumers or combustion units 20, which (for example due to different load states, operating states and/or output levels) at least in part require a different fuel parameter value (e.g. a fuel pressure value), can also not be supplied from the decoupling vessel 300 there. In design embodiments the fuel supply line 110 can be optional, for example when the fuel compressor 200 is able to be connected directly to the fuel source 11, or is connected directly to the latter. The decoupling vessel 300 can comprise at least one outlet valve element by means of which an outlet of fuel into the fuel distribution line 130 from the decoupling vessel 300 can be controlled.

The fuel can be a gaseous fuel, in particular propane, natural gas, hydrogen or biogas. In design embodiments the fuel can also be liquid. In design embodiments a pre-evaporator which is conceived to convert the fuel into a gaseous form can be provided in the fuel supply line. The fuel source 11 can be a supply network, in particular a supply network of a decentralized energy supply, for example. In other design embodiments the fuel source 11 can be a fuel store.

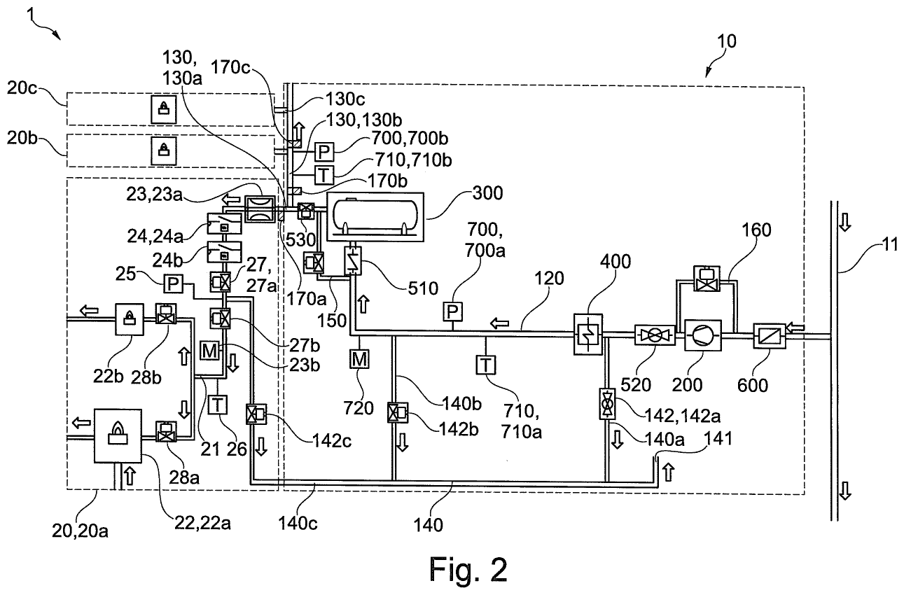

FIG. 2 shows a detailed view of the fuel supply system 10 according to the invention, and of the at least one combustion unit 20 from FIG. 1. As illustrated in FIGS. 1 and 2, the fuel supply system 10 can comprise exactly one fuel compressor 200, in particular a high-pressure fuel compressor. Savings can be made in terms of components because only one fuel compressor 200 is required, even when a plurality of combustion units 20, 20a, 20b, 20c, 20d are supplied with fuel. Likewise, costs can be reduced, and the complexity of the entire power generation system 1 can be reduced. In design embodiments the fuel compressor 200 can be a first fuel compressor, and the fuel supply system 10 can comprise at least one second fuel compressor (not shown in the figures), the latter in particular potentially being disposed downstream in the fuel main line 120 of the first fuel compressor. For example, the at least one second fuel compressor can be provided to improve a redundancy of the system and/or to achieve a target pressure in the decoupling vessel by way of at least one intermediate pressure. For example, the first fuel compressor can be a low-pressure compressor, and the at least one second fuel compressor can be a high-pressure compressor. For example, intercooling for increasing the efficiency can be provided between the two compressors.

In design embodiments the fuel supply system 10 can comprise a fuel compressor bypass 160 which fluidically connects the fuel supply line 110 and the fuel main line 120, and is conceived to supply fuel from the fuel supply line 110 to the fuel main line 120 while bypassing the fuel compressor 200. For example, the fuel source 11 can already provide fuel at a specific pressure level, or comprise a supercharger which provides fuel at a specific pressure level. If this pressure level corresponds at least to the fuel pressure target value in the decoupling vessel 300, for example in low-load states of the at least one combustion unit 20, the fuel compressor bypass 160 can be opened, or closed again when required, by means of a bypass valve element.

As is schematically illustrated in FIGS. 1 and 2, the fuel distribution line 130 can be able to be fluidically connected (or be connected) to at least two combustion units 20, 20a, 20b, 20c, 20d of the power generation system 1, and be conceived to supply the at least two combustion units 20, 20a, 20b, 20c, 20d with fuel from the decoupling vessel 300. The fuel distribution line 130 in FIGS. 1 and 2 is illustrated so as to be connected to the at least two combustion units 20, 20a, 20b, 20c, 20d. In other words, only one (single) fuel supply system 10 can be provided in order to supply a plurality of combustion units 20, 20a, 20b, 20c, 20d with fuel. This is made possible by the decoupling vessel 300. In particular, the fuel distribution line 130 can comprise at least two sub-lines 130a, 130b, 130c, 130d which are in each case connected to the at least two combustion units 20, 20a, 20b, 20c, 20d. The at least two sub-lines 130a, 130b, 130c, 130d can in each case branch off from the fuel distribution line 130 and fluidically connect the fuel distribution line 130 to the respective combustion unit 20, 20a, 20b, 20c, 20d.

With reference to FIGS. 1, 2 and 5, in design embodiments the fuel distribution line 130 can have a plurality of, or at least two, sub-lines 130a, 130b, 130c which are provided separately from one another and connect a respective combustion unit 20, 20a, 20b, 20c, 20d separately to the decoupling vessel 300. In this design embodiment the decoupling vessel 300 can comprise at least two vessel chambers 310a, 310b, 310c which are provided so as to be fluidically separated from one another. The vessel chambers 310a, 310b, 310c can in each case have the same volume, or a different volume. Alternatively, a plurality of decoupling vessels having in each case exactly one vessel chamber 310a, 310b, 310c can be provided. In yet again other design embodiments a plurality of decoupling vessels having a plurality of vessel chambers can be provided. Each vessel chamber 310a, 310b, 310c can be connected to a respective separate sub-line 130a, 130b, 130c of the fuel distribution line 130. In this way, each vessel chamber 310a, 310b, 310c can be connected, or is to be connected, separately to a respective combustion unit 20, 20a, 20b, 20c, 20d by way of the corresponding sub-line 130a, 130b, 130c. In these design embodiments the fuel main line 120 can have at least two sub-lines 120a, 120b, 120c which are in each case connected to one vessel chamber 310a, 310b, 310c. The at least two sub-lines 120a, 120b, 120c here can in each case branch off from the fuel main line 120 and connect in each case the fuel main line 120 to a corresponding vessel chamber 310a, 310b, 310c. Consequently, in these design embodiments, each combustion unit is, or is to be, able to be fluidically connected, or is fluidically connected, in each case to one vessel chamber 310a, 310b, 310c by means of a separate sub-line 130a, 130b, 130c of the fuel distribution line 130, and each vessel chamber 310a, 310b, 310c is connected to the fuel main line 120 by means of a respective sub-line 120a, 120b, 120c of the fuel main line 120. In design embodiments there can be exactly two, three or four sub-lines 120a, 120b, 120c of the fuel main line 120, exactly two, three or four sub-lines 130a, 130b, 130c of the fuel distribution line 130, and correspondingly two, three or four vessel chambers 310a, 310b, 310c.

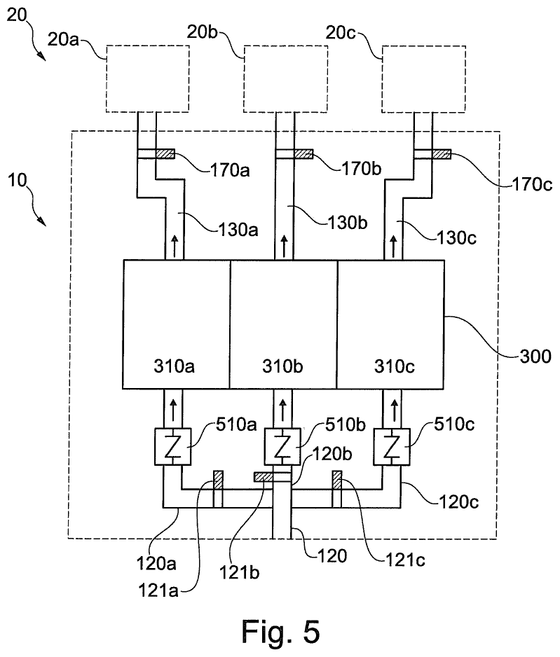

In all embodiments described above (see FIGS. 2 and 5) a distribution valve element 170a, 170b, 170c, 170d can be provided in at least one or each of the at least two sub-lines 130a, 130b, 130c, 130d of the fuel distribution line 130. This distribution valve element 170a, 170b, 170c, 170d can be conceived to control a fuel proportion that is to be supplied to the respective one of the at least two combustion units 20, 20a, 20b, 20c, 20d. The at least one distribution valve element 170a, 170b, 170c, 170d can be provided additionally or alternatively to a pressure adjustment element 24 in the at least one combustion unit 20 (as will be explained in more detail further below). The distribution valve element 170a, 170b, 170c, 170d can also function as a throttle valve and/or proportional valve. In design embodiments the distribution valve element 170a, 170b, 170c, 170d can likewise function as a pressure adjustment element. The at least one distribution valve element 170a, 170b, 170c, 170d may not be provided in other design embodiments. In one design embodiment the fuel distribution line 130 can be connected to only one combustion unit 20. Only one distribution valve element may be provided in this design embodiment. In other design embodiments the pressure adjustment elements 24 in the combustion unit 20 can suffice so that the distribution valve element can be dispensed with. In those design embodiments in which the fuel main line 120 has at least two sub-lines 120a, 120b, 120c (see FIG. 5, for example) a distribution valve element 121a, 121b, 121c can be provided in at least one, or all, of the at least two sub-lines 120a, 120b, 120c of the fuel main line 120. Fuel with a specific fuel parameter value, in particular fuel pressure, can be provided in the respective vessel chamber 310a, 310b, 310c by means of the distribution valve element 121a, 121b, 121c. In other words, a respective fuel parameter value can be provided in the respective vessel chamber 310a, 310b, 310c on account of the distribution valve element 121a, 121b, 121c. If no distribution valve element 121a, 121b, 121c is provided, the same fuel parameter target value (e.g. the fuel parameter value that is provided in the fuel main line 120) can be provided in each vessel chamber 310a, 310b, 310c.

In design embodiments the fuel distribution line 130 can be able to be fluidically connected (or can be fluidically connected) to at least three combustion units 20a, 20b, 20c, or at least four combustion units 20a, 20b, 20c, 20d, and be conceived to supply the at least three combustion units 20a, 20b, 20c or the at least four combustion units 20a, 20b, 20c, 20d with fuel from the decoupling vessel 300. In one design embodiment only exactly one combustion unit 20, 20a may also be provided. The fuel distribution line 130 can be able to be fluidically connected (or can be fluidically connected) to the latter, and be conceived to supply the latter with fuel from the decoupling vessel 300. As is shown in FIG. 1, exactly four combustion units 20a, 20b, 20c, 20d can be provided. As is shown in FIG. 2, exactly three combustion units 20a, 20b, 20c can be provided. Exactly two combustion units 20a, 20b can be provided in design embodiments. The number of combustion units 20 can be a function of the overall output of the power generation system 1 to be provided (as will be described further below). Accordingly, more than four combustion units can also be provided and be supplied with fuel from the decoupling vessel 300.

The fuel supply system 10 can comprise exactly one decoupling vessel 300 (see FIG. 1 or 2, for example). In design embodiments a plurality of decoupling vessels 300 can also be provided. The latter can be provided so as to be mutually parallel and in particular in each case connected to the fuel main line 120 and the fuel distribution line 130. As a result, an energetic optimization can be provided in the case of greatly different output levels of a plurality of gas turbines 2, 2a, 2b. As described above, in design embodiments the decoupling vessel 300 can comprise a plurality of vessel chambers. Alternatively, the decoupling vessel 300 can comprise exactly one vessel chamber. The fuel supply system 10 can in all design embodiments, as is shown in FIG. 2, comprise a decoupling vessel bypass 150 which fluidically connects the fuel main line 120 and the fuel distribution line 130, and is conceived to supply fuel from the fuel main line 120 to the fuel distribution line 130 while bypassing the decoupling vessel 300. In particular, a first bypass valve can be disposed in the decoupling vessel bypass 150. The decoupling vessel bypass 150 can be used when a plurality of combustion units are supplied which at a point in time comprise in each case the same operating levels and/or operating states or load states. The decoupling vessel bypass 150 can be used when the at least one combustion unit is operated in a low-load state. The decoupling vessel bypass 150 can also be used when only one combustion unit 20 is supplied with fuel. If the at least two separate sub-lines 130a, 130b, 130c of the fuel distribution line 130 are provided (see FIG. 5), the decoupling vessel bypass 150 can connect the fuel main line 120 to the respective separate sub-lines 130a, 130b, 130c. In this case, the bypass can have a plurality of bypass sub-lines. The latter can in each case have one bypass valve.

As is shown in FIGS. 1 and 2, the fuel supply system 10 can comprise a fuel heat exchanger 400. The latter can be disposed in the fuel main line 120 so as to be downstream of the fuel compressor 200, and be conceived to discharge heat from the fuel main line 120. It can in particular be necessary that a fluid temperature (e.g. a gas temperature) in the fuel main line 120 is limited to a maximum valve fluid temperature. Accordingly, a thermal flow from the fluid in the fuel main line 120 can be introduced into a cooling medium (e.g. oil, gas, water or air) in the heat exchanger.

The fuel supply system 10 can comprise at least one ventilation line 140 which fluidically connects the fuel main line 120 and an atmospheric outlet 141 of the ventilation line 140 (or of the fuel supply system 10) (see FIG. 2). The fuel main line 120 can be ventilated by the at least one ventilation line 140 so that a defined system state of the fuel supply system 10 can be achieved. At least one ventilation valve 142 can be provided in the at least one ventilation line 140. In an open position of the at least one ventilation valve 142, the ventilation line 140 is conceived to discharge fuel from the fuel main line 120. The at least one ventilation line 140 can be able to be fluidically connected (or can be fluidically connected) to a combustion unit supply line 21, and be conceived to discharge fuel from the combustion unit supply line 21. As is shown in FIG. 2, the at least one ventilation line 140 can comprise a first ventilation line 140a which at a position between the fuel heat exchanger 400 and the fuel compressor 200 fluidically connects the fuel main line 120 and the atmospheric outlet 141. A first ventilation valve 142a can be disposed in the first ventilation line 140a. The at least one ventilation line 140 can comprise a second ventilation line 140b which at a position between the fuel heat exchanger 400 and the decoupling vessel 300 fluidically connects the fuel main line 120 and the atmospheric outlet 141. A second ventilation valve 142b can be disposed in the second ventilation line 140b. The at least one ventilation line 140 can comprise at least one third ventilation line 140c which fluidically connects the combustion unit supply line 21 of the at least one combustion unit 20 and the atmospheric outlet 141. A third ventilation valve 142c can be disposed in the at least one third ventilation line 140c.

As is shown in FIG. 2, the fuel supply system 10 can comprise at least one check valve 510 which is disposed in the fuel main line 120 so as to be upstream of the decoupling vessel 300. The check valve 510 can prevent a return flow of compressed fuel from the decoupling vessel 300, in particular when the fuel compressor 200 is not being operated, or is being operated at low rotating speeds (and only a pressure is built up that is lower than a pressure in the decoupling vessel 300). In those design embodiments in which at least two sub-lines 120a, 120b, 120c of the fuel main line 120 are provided (see FIG. 5, for example), a check valve 510a, 510b, 510c can alternatively or additionally be provided in each sub-line 120a, 120b, 120c.

Furthermore, the fuel supply system 10 can comprise at least one first shut-off valve 520 which is disposed in the fuel main line 120 so as to be downstream of the fuel compressor 200. Alternatively or additionally, the shut-off valve can be disposed upstream of the fuel compressor 200. The fuel supply can be quickly and centrally shut off or suppressed by means of the first shut-off valve 520, for example in a hazardous situation, an emergency situation or a maintenance situation.

As is schematically illustrated in FIG. 2, a filter device 600 can be disposed in the fuel supply line 110 so as to be upstream of the fuel compressor 200. In particular, the filter device 600 can be a gas filter device, in particular when the fuel is gaseous. Contaminations can be separated from the fuel by the filter device 600.

The fuel supply system 10 can comprise at least one pressure reduction valve 530 which is disposed in the fuel distribution line 130 so as to be downstream of the decoupling vessel 300 (and in particular ahead of any potential sub-lines 130a, 130b, 130c). A pressure level directly downstream of the decoupling vessel 300 can be adjusted by means of the pressure reduction valve 530. In those design embodiments in which at least two separate sub-lines 130a, 130b, 130c of the fuel distribution line 120 are provided (see FIG. 5, for example), a pressure reduction valve can alternatively or additionally be provided in each sub-line 130a, 130b, 130c.

The fuel supply system 10 can comprise at least one first pressure sensor 700, 700a, 700b and/or one first temperature sensor 710, 710a, 710b which is disposed in the fuel supply line 110, the fuel main line 120 and/or in the fuel distribution line 130. In design embodiments the fuel supply system 10 can comprise at least one first mass flow sensor 720 which is disposed in the fuel main line 120 so as to be upstream of the decoupling vessel 300, and is conceived to measure a mass flow in the fuel main line 120 ahead of the decoupling vessel 300. The fuel compressor 200 can be controlled by means of sensor data of the at least one pressure sensor, temperature sensor and/or mass flow sensor. In those design embodiments in which at least two separate sub-lines 130a, 130b, 130c of the fuel distribution line 120, and/or at least two sub-lines 120a, 120b, 120c of the fuel distribution line 120 are provided (see FIG. 5, for example), a pressure sensor, mass flow sensor and/or temperature sensor can be provided in the corresponding sub-line.

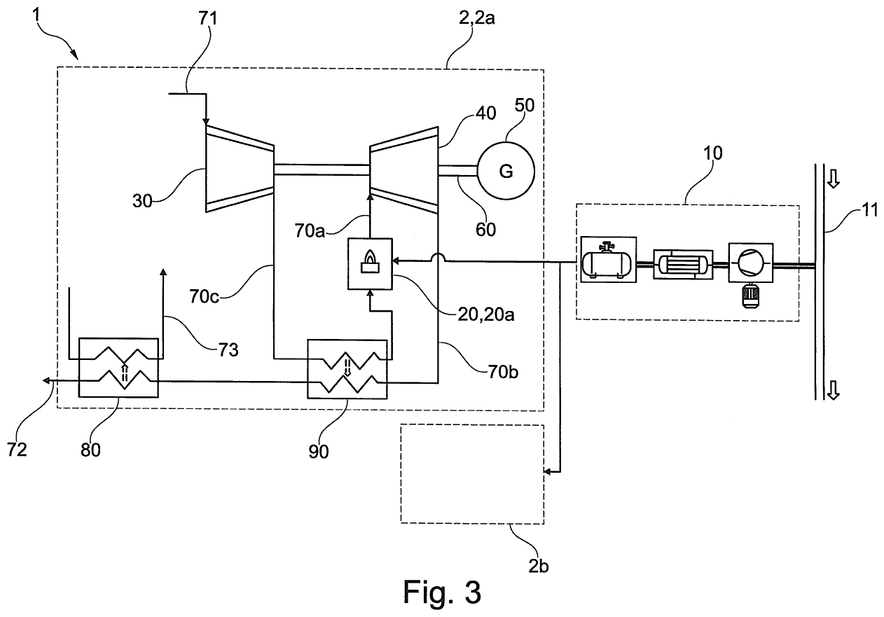

FIG. 3 shows a power generation system 1 according to the invention, having the fuel supply system 10 and at least one gas turbine 2, 2a, 2b. The power generation system 1 comprises the fuel supply system 10 according to the invention, and at least one combustion unit 20. The at least one combustion unit 20 is disposed downstream of the fuel supply system 10, and is fluidically connected to the decoupling vessel 300 by way of the fuel distribution line 130, wherein the at least one combustion unit 20 is supplied with fuel from the decoupling vessel 300 (see also FIG. 2).

The power generation system 1, in particular the gas turbine system or micro gas turbine system, can comprise at least one (micro) gas turbine 2 which has the at least one combustion unit 20. The fuel distribution line 130 can be able to be fluidically connected (or can be fluidically connected) to the combustion unit 20 of the at least one gas turbine 2 of the power generation system 1, and be conceived to supply the combustion unit 20 of the at least one gas turbine 2 with fuel from the decoupling vessel 300. As is shown in FIG. 3, the power generation system 1 can comprise at least two (micro) gas turbines 2, 2a, 2b which have in each case one combustion unit 20, 20a, 20b. The fuel distribution line 130 can be able to be fluidically connected (or can be fluidically connected) to the respective combustion unit 20, 20a, 20b of the at least two gas turbines 2, 2a, 2b of the power generation system 1, and be conceived to supply the respective combustion units 20, 20a, 20b of the at least two gas turbines 2, 2a, 2b with fuel from the decoupling vessel 300.

In design embodiments the at least two gas turbines 2, 2a, 2b can provide the same output, or provide different outputs. In design embodiments the power generation system 1 can provide an overall output of 1 MW. In a first example, the power generation system 1 can comprise three gas turbines each having an output of 333 kW in order to provide the overall output. In this case, all gas turbines deliver the same output (e.g. electrical output and/or thermal output). The respective combustion units 20a, 20b, 20c can be supplied with fuel with approximately the same pressure level and/or mass flow from the decoupling vessel 300. In a further example, four gas turbines can be provided, wherein two gas turbines have in each case an output of 200 kW, and two gas turbines have in each case an output of 300 kW in order to be able to provide the overall output of 1 MW. Consequently, four gas turbines can be used which at least in part can be operated at different operating points or load states. The gas turbines with the higher output can have a higher fuel requirement (or require fuel with a higher pressure and/or mass flow) than the gas turbines with the lower output. The decoupling vessel 300 can provide fuel with a fuel pressure target value which corresponds to at least the highest required fuel pressure value of the four gas turbines, or combustion units of the gas turbines. In design embodiments the decoupling vessel 300 can have a capacity of approx. 2000 liters. The respective fuel requirement (or fuel with a required fuel parameter value, in particular a fuel pressure and/or mass flow) to the individual combustion units 20 of the gas turbines 2, 2a, 2b can then be controlled by way of the at least one pressure adjustment element 24 (described further below), corresponding proportional valves 22 and/or the at least one distribution valve element 170a, 170b, 170c, 170d. Only one (single) fuel supply system 10 according to the invention having the decoupling vessel 300 is required in order to be able to provide the corresponding fuel for such power generation systems 1 having a plurality of gas turbines 2, 2a, 2b. Consequently, components can be saved, a necessary space requirement can be reduced, the complexity and/or costs can be reduced in particular for systems having a plurality of gas turbines 2, 2a, 2b, because a fuel supply system 10 does not have to be provided for each combustion unit 20, or gas turbine 2. In this example, the highest required fuel pressure value can be approx. 12 bar in at least one of the gas turbines 2, 2a, 2b. The fuel source 11 can provide fuel with a pressure value of approx. 5 bar. The fuel supply system 10 can predefine a fuel pressure target value of approx. 14 bar in the decoupling vessel 300. This fuel pressure target value can be higher than the highest required fuel pressure value, so as to take into account potential losses. The fuel compressor 200 can be correspondingly controlled in order to provide the fuel pressure of approx. 5 bar from the fuel source 11 to be raised to approx. 14 bar in the decoupling vessel 300. The method 800 described hereunder can be used for controlling the fuel supply system 10 and/or the power generation system 1. What has been mentioned above also applies to the design embodiments in which a plurality of vessel chambers 310a, 310b, 310c are provided (see FIG. 5), the latter being fluidically connected to the respective combustion units of the gas turbines by way of the separate sub-lines 130a, 130b, 130c. Fuel with a required fuel parameter value for the respective gas turbine can be provided in the respective vessel chamber 310a, 310b, 310c by way of the components described (such as, for example, pressure adjustment elements (described further below), corresponding proportional valves and/or distribution valve elements).

As is shown in FIG. 2, the at least one combustion unit 20 can comprise a combustion unit supply line 21 and at least one burner 22, wherein the combustion unit supply line 21 fluidically connects the burner 22 to the fuel distribution line 130 (or corresponding sub-lines). The at least one burner 22 can comprise a main burner 22a and a pilot burner 22b. The combustion unit 20 can have at least one second mass flow sensor 23, 23a, 23b which is disposed in the combustion unit supply line 21, and is conceived to measure a mass flow in the combustion unit supply line 21. In design embodiments a first mass flow sensor 23a can be provided at a first end of the combustion unit supply line 21, said end being connected to the fuel distribution line 130. A second mass flow sensor 23b can be provided in the combustion unit supply line 21 ahead of the burner 22.

As already briefly mentioned above and schematically illustrated in FIG. 2, the at least one combustion unit 20 can have at least one pressure adjustment element 24, 24a, 24b which is disposed in the combustion unit supply line 21, and is conceived to adjust a required fuel parameter value of the fuel (e.g. fuel with a fuel pressure value) in the combustion unit supply line 21. The at least one pressure adjustment element 24 can be conceived to maintain the fuel parameter value (in particular the fuel pressure value) between a lower and an upper pressure threshold value. In design embodiments the required fuel parameter value can correspond to the fuel pressure target value. In particular, a first pressure adjustment element 24a and a second pressure adjustment element 24b can be provided. The first pressure adjustment element 24a can be conceived to maintain the fuel pressure value at or above a lower pressure threshold value. The second pressure adjustment element 24b can be conceived to maintain the fuel pressure value at or below an upper pressure threshold value. The first pressure adjustment element 24a herein can be disposed in the combustion unit supply line 21 so as to be upstream of the second pressure adjustment element 24b.

The at least one combustion unit 20 can comprise at least one second pressure sensor 25 and/or one second temperature sensor 26 which is disposed in the combustion unit supply line 21. Furthermore, the at least one combustion unit 20 can comprise a first proportional valve 28a and at least one second proportional valve 28b. The first proportional valve 28a can be disposed in a first sub-line of the combustion unit supply line 21 so as to be upstream of the main burner 22a. The second proportional valve 28b can be disposed in a second sub-line of the combustion unit supply line 21 so as to be upstream of the pilot burner 22b. The first proportional valve 28a and the at least one second proportional valve 28b are conceived to control a fuel proportion that is in each case to be supplied to the main burner 22a and to the pilot burner 22b. Alternatively or additionally, the fuel mass flow in the combustion unit supply line 21 and/or in the fuel distribution line 130 can be controlled as a function of a pressure value (in particular the fuel pressure target value) which is adjustable in the fuel compressor 200, in particular by means of an adjustable rotating speed of the fuel compressor 200.

In design embodiments the at least one combustion unit 20 can have at least one second shut-off valve 27, 27a, 27b which is disposed in the combustion unit supply line 21. The at least one second shut-off valve 27, 27a, 27b can be disposed downstream of the pressure adjustment element 24. As is shown in FIG. 2, two shut-off valves 27a, 27b can be disposed in the combustion unit supply line 21. Between these two shut-off valves 27a, 27b, the third ventilation line 140c can be connected to the combustion unit supply line 21. The second pressure sensor 25 can likewise be provided between the two shut-off valves 27a, 27b, so as to control the third ventilation valve 142c as a function of pressure sensor data.

In design embodiments the at least one gas turbine 2 can comprise a compressor unit 30, as is shown in FIGS. 2 and 3, which is disposed upstream of the combustion unit 20 and is fluidically connected to the latter. Fluid (in particular air) to be compressed can be supplied to the compressor unit by way of a compressor unit supply line 71. The compressor unit 30 can be fluidically connected to a mixing zone of the at least one burner 22, and be conceived to supply compressed air to the mixing zone. The mixing zone can be conceived to mix the fuel and the compressed air. In design embodiments the mixing zone here can be provided ahead of, or in, a portion of a combustion chamber of the at least one burner 22. The fuel can be pre-heated by the hot compressed air, which can promote reaction kinetics in the mixing zone, and in particular in the combustion chamber.

The at least one gas turbine 2 can comprise a turbine unit 40 which is disposed downstream of the combustion unit 20 and is fluidically connected to the latter. As is furthermore illustrated in FIG. 3, the at least one gas turbine 2 can comprise a generator unit 50 which is operatively coupled to the turbine unit 40. The at least one gas turbine 2 can comprise a shaft 60 which is rotationally mounted in a bearing housing. A rotor of the generator unit 50 can be co-rotationally coupled to a turbine wheel of the turbine unit 40 by way of the shaft 60. “Operatively” means that the turbine unit can generate a rotating movement of the shaft as a result of the relaxation of fluid from the combustion unit, which rotating movement is then transmitted to the rotor of the generator unit (which consequently generates electric power). In design embodiments the turbine unit 40 can be co-rotationally coupled to the compressor unit 30 by way of the shaft 60. In design embodiments the compressor unit 30 can be supplied with electric power which has been generated by the generator unit 50 and is used to drive a compressor wheel. The latter can be provided for the fuel compressor 200 of the fuel supply system 10.

As is shown in FIG. 3, the at least one gas turbine 2 can have a first gas turbine line 70a and a second gas turbine line 70b. The first gas turbine line 70a can fluidically connect the turbine unit 40 to the combustion unit 20. The second gas turbine line 70b can be disposed downstream of the turbine unit 40 and be fluidically connected to the latter. The second gas turbine line 70b is conceived to discharge relaxed fluid from the turbine unit 40.

In design embodiments the at least one gas turbine 2 can comprise a third gas turbine line 70c which fluidically connects the compressor unit 30 to the combustion unit 20, and is conceived to supply compressed air from the compressor unit 30 to the combustion unit 20.

In design embodiments the at least one gas turbine 2 can comprise at least one recuperator unit 90. The at least one recuperator unit 90 can be disposed in the first gas turbine line 70a and the second gas turbine line 70b in such a manner and specified in such a manner so as to transmit a thermal output from the first gas turbine line 70a to the second gas turbine line 70b (not shown in FIG. 3). Alternatively or additionally, the at least one recuperator unit 90 can be disposed between the third gas turbine line 70c and the second gas turbine line 70b in such a manner and be specified in such a manner so as to transmit a thermal output from the second gas turbine line 70b to the third gas turbine line 70c, in particular to the portion of the third gas turbine line 70c between the recuperator 90 and the combustion unit 20 (as is shown in FIG. 3). The thermal output transmitted by the recuperator 90 can be utilized to further heat the compressed air ahead of the combustion unit, in particular the combustion chamber of the burner. An efficiency of the power generation system 1 can be increased as a result, because the energy supplied by the heat no longer has to be supplied by fuel energy. Also, the recuperator unit can comprise a first recuperator unit and a second recuperator unit which are disposed at the positions described above. In one example, the following temperature sequence can arise at a nominal load of the power generation system 1: in the third gas turbine line 70c, the temperature of the air prior to entering the recuperator 90 (disposed as shown in FIG. 3) can be approx. 250° C. At the exit of the recuperator 90, the temperature of the air can be approx. 500° C. At the exit of the at least one combustion chamber 20, 20a in the first gas turbine line 70a, the fluid (in particular exhaust gas) can have a temperature of approx. 1050° C. After exiting the turbine unit 40, the relaxed fluid in the second gas turbine line 70b, prior to entering the recuperator 90, can have a temperature of approx. 700° C. At the exit of the recuperator 90, the fluid in the second gas turbine line 70b can have a temperature of approx. 550° C.

As is furthermore illustrated in FIG. 3, the second gas turbine line 70b is fluidically connected to a fluid outlet 72. In design embodiments at least one additional heat exchanger 80 can be provided in the second gas turbine line 70b. This additional heat exchanger 80 can be disposed between the second gas turbine line 70b, downstream of the at least one recuperator 70, and an external line 73 in such a manner and be conceived in such a manner so as to transmit a thermal output from the second gas turbine line 70b to the external line 73.

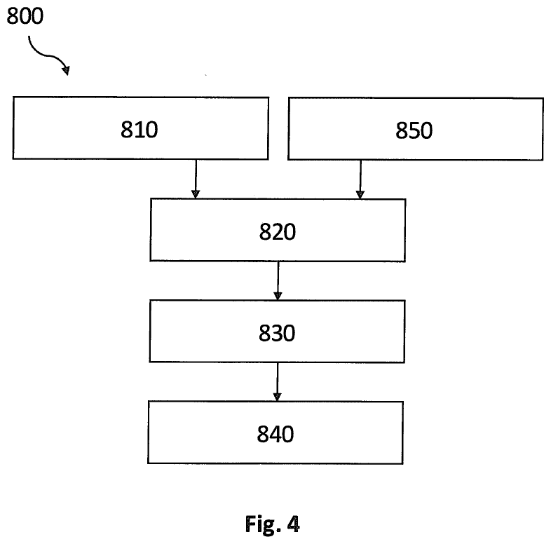

FIG. 4 shows a schematic sequence diagram of the method according to the invention for controlling the fuel supply system 10 for a power generation system, in particular for a gas turbine system or a micro gas turbine system. The fuel supply system 10 according to the invention, and the power generation system 1 comprising the fuel supply system 10, can be controlled by the method.

The method 800 according to the invention for controlling the fuel supply system 10 comprises the following steps:
a) requesting and obtaining 810 at least one fuel parameter target value which is linked to fuel in a decoupling vessel 300;
b) determining 820, based on the at least one fuel parameter target value, at least one operating parameter value of a fuel compressor 200 which is fluidically connected to the decoupling vessel 300;
c) operating 830 the fuel compressor 200 based on the at least one operating parameter, so as to provide fuel with the at least one fuel parameter target value in the decoupling vessel 300.

This method 800 can provide the advantageous effects of the fuel supply system 10 and of the power generation system 1 described above. Moreover, optimized and tailored control of the fuel supply system 10, or of the power generation system 1, can be provided by means of the method 800. The method 800 can be applied in an analogous manner for controlling the power generation system 1. According to one aspect of the present invention, a method for controlling a power generation system 1, in particular a (micro) gas turbine system, can consequently comprise all steps and features of the method 800 described. The fuel supply system 10 and the power generation system 1 can comprise the features or design embodiments described above. In particular, a fuel distribution line 130 is disposed downstream of the decoupling vessel 300 and fluidically connected to the latter. The fuel distribution line 130 is able to be fluidically connected (or is fluidically connected) to at least one combustion unit 20 of the power generation system 1, and conceived to supply the at least one combustion unit 20 with fuel with the at least one fuel parameter target value from the decoupling vessel 300.

The method 800 can furthermore comprise supplying 840 at least one combustion unit 20 with fuel with the at least one fuel parameter target value from the decoupling vessel 300. The at least one fuel parameter target value can be a fuel pressure target value of the fuel in the decoupling vessel 300. The at least one operating parameter value can be a rotating speed of the fuel compressor 200.

As described above, the power generation system 1 can comprise a first gas turbine 2, 2a and at least one second gas turbine 2, 2b. Requesting and obtaining 810 at least one fuel parameter target value can comprise the following steps:
obtaining a first required fuel parameter value which is linked to fuel that is required for supplying a combustion unit 20, 20a of the first gas turbine 2, 2a; and
obtaining at least one second required fuel parameter value which is linked to fuel that is required for supplying a combustion unit 20, 20b of the at least one second gas turbine 2, 2b.

Moreover, requesting and obtaining 810 the at least one fuel parameter target value can comprise the following steps:
determining which fuel parameter value of the first required fuel parameter value and of the at least one second required fuel parameter value has the highest required fuel parameter value; and
establishing the fuel parameter target value in such a manner that it corresponds at least to the highest required fuel parameter value.

In other words, the fuel parameter target value can be established in such a way that it is equal to or greater than the highest required fuel parameter value. The first required fuel parameter value and the at least one second required fuel parameter value can in each case be a required fuel pressure value.

In design embodiments the method 800 can furthermore comprise the following steps:
requesting and obtaining 850 at least one second fuel parameter target value which is linked to fuel in a fuel distribution line 130, wherein the fuel distribution line 130 is disposed downstream of the decoupling vessel 300 and is fluidically connected to the latter;
determining the at least one operating parameter value of the fuel compressor 200 based on the at least one second fuel parameter target value; and
operating the fuel compressor 200 based on the at least one operating parameter so as to provide fuel with the at least one second fuel parameter target value in the fuel distribution line 130.

The at least one second fuel parameter target value can be a fuel mass flow in the fuel distribution line 130. In design embodiments the at least one second fuel parameter target value can also be a fuel mass flow in the combustion unit supply line 21 of the at least one combustion unit 20. In this case, the method can comprise requesting and obtaining 850 at least one second fuel parameter target value which is linked to fuel in a combustion unit supply line 21, wherein the combustion unit supply line 21 is disposed downstream of the decoupling vessel 300 and is fluidically connected to the fuel distribution line 130.

In those design embodiments in which at least two vessel chambers 310a, 310b, 310c are present and in each case fluidically connected to the at least two combustion units, requesting and obtaining 810 of the at least one fuel parameter target value can alternatively or additionally comprise the following steps:
requesting and obtaining 810 a fuel parameter target value which is linked to fuel in a first vessel chamber 310a of the decoupling vessel 300;
requesting and obtaining 810 at least one further fuel parameter target value which is linked to fuel in at least one second vessel chamber 310b, 310c of the decoupling vessel 300.

In these design embodiments, requesting and obtaining 810 the at least one fuel parameter target value can furthermore comprise the following steps:
obtaining a first required fuel parameter value which is linked to fuel that is required for supplying a combustion unit 20, 20a of the first gas turbine 2, 2a, wherein the first combustion unit 20, 20a is connected to the first vessel chamber 310a; and
obtaining at least one second required fuel parameter value which is linked to fuel that is required for supplying a combustion unit 20, 20b of the at least one second gas turbine 2, 2b, wherein the at least one second combustion unit 20, 20b is connected to the at least one second vessel chamber 310a.

Because the respective combustion unit 20, 20a, 20b is connected to the respective vessel chamber, the first required fuel parameter value can thus be linked to the fuel parameter target value in the first vessel chamber, and the at least one second required fuel parameter value can be linked to the at least one further fuel parameter target value in the at least one second vessel chamber. Moreover, requesting and obtaining 810 the at least one fuel parameter target value can comprise the following steps:
determining which fuel parameter value of the first required fuel parameter value and of the at least one second required fuel parameter value has the highest required fuel parameter value; and establishing the fuel parameter target value in such a manner that it corresponds to at least the highest required fuel parameter value.

Because the respective required fuel parameter values are linked to the respective fuel parameter target values, it is ensured that the highest fuel parameter target value is provided in that vessel chamber that is connected to the combustion unit with the highest required fuel parameter value. The at least one operating parameter value of the fuel compressor 200 which is fluidically connected to the first vessel chamber 310a and the at least one second vessel chamber can then be correspondingly determined (step 820). Moreover, the fuel compressor 200 can be operated based on the at least one operating parameter so as to provide fuel with the at least one fuel parameter target value in the first vessel chamber 310a and/or the at least one second vessel chamber 310b, 310c of the decoupling vessel 300. If no distribution valve elements 121a, 121b, 121c are provided in the separate sub-lines 120a, 120b, 120c of the fuel main line described above, the same (highest) fuel parameter target value can be provided in each vessel chamber. If distribution valve elements 121a, 121b, 121c are provided, the method can comprise activating these distribution valve elements 121a, 121b, 121c so as to provide fuel parameter target values corresponding to the respective required fuel parameter values in the respective vessel chambers 310a, 310b, 310c. In this case too, the fuel compressor 200 is operated in such a manner that it provides the fuel parameter target value which is equal to or greater than the highest required fuel parameter value.

In design embodiments the method 800 can be a computer-implemented method. Supplying 840 at least one combustion unit 20 with fuel with the at least one fuel parameter target value herein can be implemented by correspondingly activating at least one outlet valve element which is provided, for example, between the decoupling vessel 300 and the fuel distribution line 130 (or the corresponding sub-lines 130a, 130b, 130c). Operating 830 the fuel compressor 200 based on the at least one operating parameter herein can be implemented by activating a drive device (for example an electric motor) which is coupled to a rotatable compressor wheel of the fuel compressor 200.

According to a further aspect of the present invention, a computer system can be configured to carry out the computer-implemented method. According to one aspect, a computer program can be configured to carry out the computer-implemented method. Furthermore, a computer-readable medium or signal can be provided, which stores the computer program.

The computer-implemented method described above can comprise a computer or a computer network, or be able to be carried out by way of a computer or a computer network, wherein the computer or the computer network comprises at least one processing unit (e.g. a processor) and at least one data memory (i.e. a memory). The procedural logic described can be stored in the form of executable code in at least one data memory, and be executed by the at least one processing unit. The systems and sub-systems (e.g. the power generation system 1 and/or the fuel supply system 10, and individual components such as the fuel compressor and the sensors) can send data to the at least one processing unit and in examples also receive instructions from the at least one processing unit. The processing unit herein can direct requests that are initiated by the user and/or automatically generated to the power generation system 1 and/or the fuel supply system. The power generation system 1 and/or the fuel supply system is not restricted to a specific hardware environment. In this way, distributed apparatuses which are connected by way of a network can carry out the techniques described herein. The disclosure also comprises electrical signals and computer-readable media which define instructions which implement the techniques described herein when executed by a processing unit. As described above, the power generation system 1 and/or the fuel supply system can comprise at least one database. Alternatively or additionally, the power generation system 1 and/or the fuel supply system 10 can access a database in a cloud (by way of a communications interface). The power generation system 1 and/or the fuel supply system 10 can comprise a (at least one) communications interface for coupling to the individual elements of the processing unit and/or the database. The communications interface can comprise one or a plurality of the following elements: a network, the internet, a local network, a wireless local network, a cellular broadband network and/or a wired network. In examples the power generation system 1 and/or the fuel supply system 10 can be connected to one or a plurality of functions by way of a server which is hosted in a cloud. Also, the power generation system 1 and/or the fuel supply system 10 can be connected to an external controlling and/or monitoring installation.

While the present invention has been described above and is defined in the appended claims, it is to be understood that the invention can alternatively also be defined according to the following embodiments:
1. Fuel supply system (10) for a power generation system (1), in particular for a micro gas turbine system, comprising:
   a fuel supply line (110), a fuel main line (120) and a fuel distribution line (130);
   a fuel compressor (200); and
   a decoupling vessel (300);
   wherein the fuel supply line (110) is fluidically connected to the fuel compressor (200) and able to be connected to a fuel source (11) in order to supply fuel from the fuel source (11) to the fuel compressor (200);
   wherein the decoupling vessel (300) is disposed downstream of the fuel compressor (200) and is fluidically connected to the fuel compressor (200) by way of the fuel main line (120);
   wherein the fuel distribution line (130) is disposed downstream of the decoupling vessel (300) and is fluidically connected to the latter; and
   wherein the fuel distribution line (130) is able to be fluidically connected to at least one combustion unit (20) of the power generation system (1), and is conceived to supply the at least one combustion unit (20) with fuel from the decoupling vessel (300).
2. Fuel supply system (10) according to embodiment 1, wherein the fuel supply system (10) comprises exactly one fuel compressor (200), in particular a high-pressure fuel compressor.
3. Fuel supply system (10) according to embodiment 1 or embodiment 2, wherein the fuel is a gaseous fuel, in particular propane, natural gas, hydrogen or biogas.
4. Fuel supply system (10) according to any of the preceding embodiments, wherein the fuel distribution line (130) is able to be fluidically connected to at least two combustion units (20, 20a, 20b) of the power generation system (1), and is conceived to supply the at least two combustion units (20, 20a, 20b) with fuel from the decoupling vessel (300);
   in particular wherein the fuel distribution line (130) comprises at least two sub-lines (130a, 130b) which are in each case connected to the at least two combustion units (20, 20a, 20b), and wherein a distribution valve element (170a, 170b) is provided in at least one, or each, of the sub-lines (130a, 130b).
5. Fuel supply system (10) according to any of the preceding embodiments, wherein the power generation system (1) comprises at least one gas turbine (2) which has the at least one combustion unit (20), and wherein the fuel distribution line (130) is able to be fluidically connected to the combustion unit (20) of the at least one gas turbine (2) of the power generation system (1), and is conceived to supply the combustion unit (20) of the at least one gas turbine (2) with fuel from the decoupling vessel (300).
6. Fuel supply system (10) according to any of the preceding embodiments, wherein the power generation system (1) comprises at least two gas turbines (2, 2a, 2b) which have in each case one combustion unit (20, 20a, 20b), and wherein the fuel distribution line (130) is able to be fluidically connected to the respective combustion unit (20, 20a, 20b) of the at least two gas turbines (2, 2a, 2b) of the power generation system (1), and is conceived to supply the respective combustion units (20, 20a, 20b) of the at least two gas turbines (2, 2a, 2b) with fuel from the decoupling vessel (300).
7. Fuel supply system (10) according to any of the preceding embodiments, comprising a fuel heat exchanger (400) which is disposed in the fuel main line (120) so as to be downstream of the fuel compressor (200), and is conceived to discharge heat from the fuel main line (120).
8. Fuel supply system (10) according to any of the preceding embodiments, comprising at least one ventilation line (140) which fluidically connects the fuel main line (120) and an atmospheric outlet (141) of the ventilation line (140).
9. Fuel supply system (10) according to embodiment 8, wherein at least one ventilation valve (142) is provided in the at least one ventilation line (140), wherein in an open position of the at least one ventilation valve (142) the ventilation line (140) is conceived to discharge fuel from the fuel main line (120).
10. Fuel supply system (10) according to embodiment 8 or embodiment 9, wherein the at least one ventilation line (140) is able to be fluidically connected to a combustion unit supply line (21), and is conceived to discharge fuel from the combustion unit supply line (21).
11. Fuel supply system (10) according to any of the preceding embodiments, comprising exactly one decoupling vessel (300).
12. Fuel supply system (10) according to any of the preceding embodiments 6 to 11, wherein the decoupling vessel (300) comprises at least two vessel chambers (310a, 310b, 310c), and wherein the fuel distribution line (130) comprises at least two separate sub-lines (130a, 130b, 130c), wherein each vessel chamber (310a, 310b, 310c) is able to be fluidically connected separately to a respective combustion unit (20, 20a, 20b) by way of a corresponding sub-line (130a, 130b, 130c), and in particular wherein the fuel main line (120) comprises at least two sub-lines (120a, 120b, 120c) which connect in each case the fuel main line (120) to a respective vessel chamber (310a, 310b, 310c).
13. Fuel supply system (10) according to any of the preceding embodiments, comprising a decoupling vessel bypass (150) which fluidically connects the fuel main line (120) and the fuel distribution line (130), and is conceived to supply fuel from the fuel main line (120) to the fuel distribution line (130) by bypassing the decoupling vessel (300).
14. Fuel supply system (10) according to any of the preceding embodiments, comprising at least one check valve (510) which is disposed in the fuel main line (120) so as to be upstream of the decoupling vessel (300).
15. Fuel supply system (10) according to any of the preceding embodiments, wherein the fuel compressor (200) is conceived to provide fuel with a fuel pressure target value in the decoupling vessel (300).
16. Fuel supply system (10) according to any of the preceding embodiments, comprising a fuel compressor bypass (160) which fluidically connects the fuel supply line (110) and the fuel main line (120), and is conceived to supply fuel from the fuel supply line (110) to the fuel main line (120) while bypassing the fuel compressor (200).
17. Fuel supply system (10) according to any of the preceding embodiments, comprising at least one first shut-off valve (520) which is disposed in the fuel main line (120) so as to be downstream or upstream of the fuel compressor (200).
18. Fuel supply system (10) according to any of the preceding embodiments, comprising a filter device (600) which is disposed in the fuel supply line (110) so as to be upstream of the fuel compressor (200).
19. Fuel supply system (10) according to any of the preceding embodiments, comprising at least one pressure reduction valve (530) which is disposed in the fuel distribution line (130) so as to be downstream of the decoupling vessel (300).
20. Fuel supply system (10) according to any of the preceding embodiments, comprising at least one first pressure sensor (700, 700a, 700b) and/or one first temperature sensor (710, 710a, 710b) which is disposed in the fuel supply line (110), the fuel main line (120) and/or in the fuel distribution line (130), and in particular comprising at least one first mass flow sensor (720) which is disposed in the fuel main line (120) so as to be upstream of the decoupling vessel (300), and is conceived to measure a mass flow in the fuel main line (120) ahead of the decoupling vessel (300).
21. Fuel supply system (10) according to any of the preceding embodiments, wherein the fuel source (11) is a supply network.
22. Power generation system (1), in particular a micro gas turbine system, comprising:
   a fuel supply system (10) according to any of the preceding embodiments; and
   at least one combustion unit (20),
   wherein the at least one combustion unit (20) is disposed downstream of the fuel supply system (10) and is fluidically connected to the decoupling vessel (300) by way of the fuel distribution line (130), wherein the at least one combustion unit (20) is supplied with fuel from the decoupling vessel (300).
23. Power generation system (1) according to embodiment 22, wherein the power generation system (1) comprises at least one gas turbine (2) which has the at least one combustion unit (20), and wherein the fuel distribution line (130) is fluidically connected to the combustion unit (20) of the at least one gas turbine (2) of the power generation system (1) and supplies the combustion unit (20) of the at least one gas turbine (2) with fuel from the decoupling vessel (300).
24. Power generation system (1) according to embodiment 22 or embodiment 23, comprising at least two combustion units (20, 20a, 20b) which are disposed downstream of the fuel supply system (10) and are fluidically connected to the decoupling vessel (300) by way of the fuel distribution line (130), wherein the at least two combustion units (20, 20a, 20b) are supplied with fuel from the decoupling vessel (300).
25. Power generation system (1) according to any of embodiments 22 to 24, wherein the power generation system (1) comprises at least two gas turbines (2, 2a, 2b) which have in each case one combustion unit (20, 20a, 20b), and wherein the fuel distribution line (130) is fluidically connected to the respective combustion unit (20, 20a, 20b) of the at least two gas turbines (2, 2a, 2b) of the power generation system (1), and supplies the respective combustion units (20, 20a, 20b) of the at least two gas turbines (2, 2a, 2b) with fuel from the decoupling vessel (300).
26. Power generation system (1) according to any of embodiments 22 to 25, wherein the at least one combustion unit (20) comprises a combustion unit supply line (21) and at least one burner (22), wherein the combustion unit supply line (21) fluidically connects the burner (22) to the fuel distribution line (130).
27. Power generation system (1) according to embodiment 26, wherein the at least one burner (22) comprises a main burner (22a) and a pilot burner (22b).
28. Power generation system (1) according to embodiment 26 or embodiment 27, wherein the fuel supply system (10) comprises at least one ventilation line (140) which fluidically connects the combustion unit supply line (21) and an atmospheric outlet (141) of the ventilation line (140).
29. Power generation system (1) according to any of embodiments 25 to 28, wherein the at least two gas turbines (2, 2a, 2b) provide the same outputs, or provide different outputs.
30. Power generation system (1) according to any of embodiments 26 to 29, wherein the combustion unit (20) has at least one second mass flow sensor (23, 23a, 23b) which is disposed in the combustion unit supply line (21) and is conceived to measure a mass flow in the combustion unit supply line (21).
31. Power generation system (1) according to any of embodiments 26 to 30, wherein the combustion unit (20) has at least one pressure adjustment element (24, 24a, 24b) which is disposed in the combustion unit supply line (21), and is conceived to adjust a fuel parameter value of the fuel, in particular a fuel pressure value, in the combustion unit supply line (21), and in particular wherein the at least one pressure adjustment element (24) is conceived to maintain the fuel pressure value between a lower and an upper pressure threshold value.
32. Power generation system (1) according to any of embodiments 26 to 31, wherein the combustion unit (20) comprises at least one second pressure sensor (25) and/or one second temperature sensor (26) which is disposed in the combustion unit supply line (21).
33. Power generation system (1) according to any of embodiments 27 to 32, comprising a first proportional valve (28a) and at least one second proportional valve (28b), wherein the first proportional valve (28a) is disposed in a first sub-line of the combustion unit supply line (21) so as to be upstream of the main burner (22a), and wherein the second proportional valve (28b) is disposed in a second sub-line of the combustion unit supply line (21) so as to be upstream of the pilot burner (22b), in particular wherein the first proportional valve (28a) and the at least one second proportional valve (28b) are conceived to control a fuel proportion that is in each case to be supplied to the main burner (22a) and to the pilot burner (22b).
34. Power generation system (1) according to any of embodiments 22 to 33, wherein the at least one gas turbine (2) comprises a compressor unit (30) which is disposed upstream of the combustion unit (20) and is fluidically connected to the latter.
35. Power generation system (1) according to embodiment 34, if dependent on embodiment 26, wherein the compressor unit (30) is fluidically connected to a mixing zone of the at least one burner (22), and is conceived to supply compressed air to the mixing zone, in particular wherein the mixing zone is conceived to mix the fuel and the compressed air.
36. Power generation system (1) according to any of embodiments 22 to 35, wherein the at least one gas turbine (2) comprises a turbine unit (40) which is disposed downstream of the combustion unit (20) and is fluidically connected to the latter.
37. Power generation system (1) according to embodiment 36, wherein the at least one gas turbine (2) comprises a generator unit (50) which is operatively coupled to the turbine unit (40).
38. Power generation system (1) according to embodiment 37, if dependent on embodiment 34, wherein the gas turbine (2) comprises a shaft (60) which is rotationally mounted in a bearing housing, wherein a rotor of the generator unit (50) is co-rotationally coupled to the turbine unit (40) by way of the shaft (60), and in particular wherein the turbine unit (40) is co-rotationally coupled to the compressor unit (30) by way of the shaft (60).
39. Power generation system (1) according to any of embodiments 36 to 38, wherein the at least one gas turbine (2) has a first gas turbine line (70a) and a second gas turbine line (70b), wherein the first gas turbine line (70a) fluidically connects the turbine unit (40) to the combustion unit (20), and wherein the second gas turbine line (70b) is disposed downstream of the turbine unit (40) and is fluidically connected to the latter, wherein the second gas turbine line (70b) is conceived to discharge relaxed fluid from the turbine unit (40).
40. Power generation system (1) according to any of embodiments 34 to 39, wherein the at least one gas turbine (2) comprises a third gas turbine line (70c) which fluidically connects the compressor unit (30) to the combustion unit (20), and is conceived to supply the combustion unit (20) with compressed air from the compressor unit (30).
41. Power generation system (1) according to embodiment 39 or embodiment 40, wherein the at least one gas turbine (2) comprises at least one recuperator unit which is disposed between the first gas turbine line (70a) and the second gas turbine line (70b) in such a manner and is specified in such a manner so as to transmit a thermal output from the first gas turbine line (70a) to the second gas turbine line (70b), and/or which is disposed between the third gas turbine line (70c) and the second gas turbine line (70b) in such a manner and is specified in such a manner so as to transmit a thermal output from the third gas turbine line (70c) to the second gas turbine line (70b).
42. Method (800) for controlling a fuel supply system (10) for a power generation system (1), in particular a fuel supply system (10) according to any of embodiments 1 to 21, comprising the following steps:
   a) requesting and obtaining (810) at least one fuel parameter target value which is linked to fuel in a decoupling vessel (300);
   b) determining (820), based on the at least one fuel parameter target value, at least one operating parameter value of a fuel compressor (200) which is fluidically connected to the decoupling vessel (300);
   c) operating (830) the fuel compressor (200) based on the at least one operating parameter, so as to provide fuel with the at least one fuel parameter target value in the decoupling vessel (300).
43. Method (800) according to embodiment 42, further comprising the following step:
   supplying (840) at least one combustion unit (20) with fuel with the at least one fuel parameter target value from the decoupling vessel (300).
44. Method (800) according to embodiment 42 or embodiment 43, wherein the at least one fuel parameter target value is a fuel pressure target value in the decoupling vessel (300).
45. Method (800) according to any of embodiments 42 to 44, wherein the at least one operating parameter value is a rotating speed of the fuel compressor (200).
46. Method (800) according to any of embodiments 42 to 45, wherein the power generation system (1) comprises a first gas turbine (2, 2a) and at least one second gas turbine (2, 2b), wherein requesting and obtaining (810) at least one fuel parameter target value comprises the following steps:
   obtaining a first required fuel parameter value which is linked to fuel that is required for supplying a combustion unit (20, 20a) of the first gas turbine (2, 2a);
   obtaining at least one second required fuel parameter value which is linked to fuel that is required for supplying a combustion unit (20, 20b) of the at least one second gas turbine (2, 2b);
   determining which fuel parameter value of the first required fuel parameter value and of the at least one second required fuel parameter value has the highest fuel parameter value; and
   establishing the fuel parameter target value in such a manner that it corresponds at least to the highest required fuel parameter value.
47. Method (800) according to any of embodiments 42 to 46, furthermore comprising the following steps:
   requesting and obtaining (850) at least one second fuel parameter target value which is linked to fuel in a fuel distribution line (130), wherein the fuel distribution line (130) is disposed downstream of the decoupling vessel (300) and is fluidically connected to the latter;
   determining (820) the at least one operating parameter value of the fuel compressor (200) based on the at least one second fuel parameter target value;
   operating (830) the fuel compressor (200) based on the at least one operating parameter so as to provide fuel with the at least one second fuel parameter target value in the fuel distribution line (130),
   in particular wherein the at least one second fuel parameter target value is a fuel mass flow in the fuel distribution line (130).
48. Method (800) according to any of embodiments 42 to 47, wherein the method is a computer-implemented method.
49. A computer system which is configured to carry out the computer-implemented method according to embodiment 48.
50. A computer program which is configured to carry out the computer-implemented method according to embodiment 48.
51. A computer-readable medium or signal which stores the computer program of embodiment 50.

1. A fuel supply system (10) for a power generation system (1), comprising:
a fuel supply line (110), a fuel main line (120), and a fuel distribution line (130);
a fuel compressor (200); and
a decoupling vessel (300);
wherein the fuel supply line (110) is fluidically connected to the fuel compressor (200) and configured to be fluidically connected to a fuel source (11) in order to supply fuel from the fuel source (11) to the fuel compressor (200);
wherein the decoupling vessel (300) is disposed downstream of the fuel compressor (200) and is fluidically connected to the fuel compressor (200) by way of the fuel main line (120);
wherein the fuel distribution line (130) is disposed downstream of the decoupling vessel (300) and is fluidically connected to the latter; and
wherein the fuel distribution line (130) is configured to be fluidically connected to at least one combustion unit (20) of the power generation system (1), and is adapted to supply the at least one combustion unit (20) with fuel from the decoupling vessel (300).

2. The fuel supply system (10) as claimed in claim 1, wherein the fuel supply system (10) comprises exactly one fuel compressor (200).

3. The fuel supply system (10) as claimed in claim 1, wherein the fuel distribution line (130) is configured to be fluidically connected to at least two combustion units (20, 20a, 20b) of the power generation system (1), and is adapted to supply the at least two combustion units (20, 20a, 20b) with fuel from the decoupling vessel (300).

4. The fuel supply system (10) as claimed in claim 3, wherein the fuel distribution line (130) comprises at least two sub-lines (130a, 130b) which are in each case connected to the at least two combustion units (20, 20a, 20b), and wherein one distribution valve element (170a, 170b) is provided in at least one or each of the sub-lines (130a, 130b).

5. The fuel supply system (10) as claimed in claim 1, comprising exactly one decoupling vessel (300).

6. The fuel supply system (10) as claimed in claim 3, wherein the decoupling vessel (300) comprises at least two vessel chambers (310a, 310b, 310c), and wherein the fuel distribution line (130) comprises at least two separate sub-lines (130a, 130b, 130c), wherein each vessel chamber (310a, 310b, 310c) is configured to be fluidically connected separately to a respective combustion unit (20, 20a, 20b) by way of a corresponding sub-line (130a, 130b, 130c), and wherein the fuel main line (120) comprises at least two sub-lines (120a, 120b, 120c) which connect in each case the fuel main line (120) to a respective vessel chamber (310a, 310b, 310c).

7. The fuel supply system (10) as claimed in claim 1, wherein the fuel compressor (200) is adapted to provide fuel with a fuel pressure target value in the decoupling vessel (300).

8. The fuel supply system (10) as claimed in claim 1, wherein the fuel source (11) is a supply network.

9. The fuel supply system (10) as claimed in claim 1, wherein the fuel is propane, natural gas, hydrogen or biogas.

10. A power generation system (1), comprising:
a fuel supply system (10) as claimed in claim 1; and
at least one combustion unit (20),
wherein the at least one combustion unit (20) is disposed downstream of the fuel supply system (10), and is fluidically connected to the decoupling vessel (300) by way of the fuel distribution line (130), wherein the at least one combustion unit (20) is supplied with fuel from the decoupling vessel (300).

11. The power generation system (1) as claimed in claim 10, wherein the power generation system (1) comprises at least two gas turbines (2, 2a, 2b) which have in each case one combustion unit (20, 20a, 20b), and wherein the fuel distribution line (130) is fluidically connected to the respective combustion unit (20, 20a, 20b) of the at least two gas turbines (2, 2a, 2b) of the power generation system (1), and supplies the respective combustion units (20, 20a, 20b) of the at least two gas turbines (2, 2a, 2b) with fuel from the decoupling vessel (300).

12. The power generation system (1) as claimed in claim 11, wherein the at least two gas turbines (2, 2a, 2b) provide the same outputs, or provide different outputs.

13. The power generation system (1) as claimed in claim 10, wherein the combustion unit (20) has at least one pressure adjustment element (24, 24a, 24b) which is disposed in the combustion unit supply line (21) and is configured to adjust a fuel parameter value of the fuel in the combustion unit supply line (21), and wherein the at least one pressure adjustment element (24) is adapted to maintain the fuel pressure value between a lower and an upper pressure threshold value.

14. Power generation system (1) as claimed in claim 10, wherein the at least one gas turbine (2) comprises a turbine unit (40) which is disposed downstream of the combustion unit (20) and is fluidically connected to the latter, and wherein the at least one gas turbine (2) comprises a generator unit (50) which is operatively coupled to the turbine unit (40).

15. The power generation system (1) as claimed in claim 10, wherein the power generation system (1) is a micro gas turbine system.

16. A method (800) for controlling a fuel supply system (10) for a power generation system (1), comprising the following steps:
a) requesting and obtaining (810) at least one fuel parameter target value which is linked to fuel in a decoupling vessel (300);
b) determining (820), based on the at least one fuel parameter target value, at least one operating parameter value of a fuel compressor (200) which is fluidically connected to the decoupling vessel (300);
c) operating (830) the fuel compressor (200) based on the at least one operating parameter, so as to provide fuel with the at least one fuel parameter target value in the decoupling vessel (300).

17. The method (800) as claimed in claim 16, wherein the at least one fuel parameter target value is a fuel pressure target value in the decoupling vessel (300), and wherein the at least one operating parameter value is a rotating speed of the fuel compressor (200).

18. The method (800) as claimed in claim 16, wherein the power generation system (1) comprises a first gas turbine (2, 2a) and at least one second gas turbine (2, 2b), wherein requesting and obtaining (810) at least one fuel parameter target value comprises: obtaining a first required fuel parameter value which is linked to fuel that is required for supplying a combustion unit (20, 20a) of the first gas turbine (2, 2a);
obtaining at least one second required fuel parameter value which is linked to fuel that is required for supplying a combustion unit (20, 20b) of the at least one second gas turbine (2, 2b);
determining which fuel parameter value of the first required fuel parameter value and of the at least one second required fuel parameter value has the highest fuel parameter value; and
establishing the fuel parameter target value in such a manner that it corresponds at least to the highest required fuel parameter value.

19. The method (800) as claimed in claim 16, wherein the method is a computer-implemented method.
